(19) United States
(12) Patent Application Publication
(10) Pub. No.: US 2026/0004549 A1
(43) Pub. Date: Jan. 1, 2026

(54) QUANTIZATION FOR IMAGE SEGMENTATION MODEL

(71) Applicant: TENCENT TECHNOLOGY (SHENZHEN) COMPANY LIMITED, Shenzhen (CN)

(72) Inventors: Weiming YANG, Shenzhen (CN); Runzeng GUO, Shenzhen (CN); Shaoming WANG, Shenzhen (CN); Jun WANG, Shenzhen (CN); Jinkun HOU, Shenzhen (CN)

(73) Assignee: TENCENT TECHNOLOGY (SHENZHEN) COMPANY LIMITED, Shenzhen (CN)

(21) Appl. No.: 19/320,728

(22) Filed: Sep. 5, 2025

Related U.S. Application Data
(63) Continuation of application No. PCT/CN2024/095741, filed on May 28, 2024.

(30) Foreign Application Priority Data
Jul. 25, 2023 (CN) 202310916069.8

(51) Int. Cl. G06V 10/26; G06V 10/72; G06V 10/776; G06V 10/82; G06V 10/94; G06V 40/18

(52) U.S. Cl. CPC G06V 10/273; G06V 10/72; G06V 10/776; G06V 10/94; G06V 40/193; G06V 10/82

(57) ABSTRACT

A computational power evaluation result of a device is obtained. The device is to be deployed with an image segmentation model, the computational power evaluation result indicates operational performance of the device. The image segmentation model includes a plurality of operators. At least a first operator is selected from the plurality of operators based on the computational power evaluation result, a data processing duration of the first operator on the device exceeds a threshold. A quantization processing is performed on the first operator based on a difference between the data processing duration of the first operator and a desired processing duration, to obtain a first quantization operator, a data processing duration of the first quantization operator on the device is less than the desired processing duration. Based on at least the first quantization operator, the image segmentation model is converted into a target model for deployment onto the device.

### RELATED APPLICATIONS

The present application is a continuation of International Application No. PCT/CN2024/095741, filed on May 28, 2024, which claims priority to Chinese Patent Application No. 202310916069.8, filed on Jul. 25, 2023. The entire disclosures of the prior applications are hereby incorporated by reference.

### FIELD OF THE TECHNOLOGY

This disclosure relates to the field of computer technologies, including techniques for quantization of an image segmentation model.

### BACKGROUND OF THE DISCLOSURE

With continuous development of Internet technologies, various image segmentation models can achieve a more refined and accurate image segmentation effect. However, the realization of this effect usually relies on high hardware cost. If these models are directly applied to low-cost hardware devices, to achieve a desired effect is difficult.

For example, in some image recognition processes, it is necessary to first perform segmentation on an image, and then perform feature extraction on the segmented image, to implement image recognition. This process consumes excessive computational power. If the foregoing process intends to be normally implemented, hardware carrying this process is required to have a relatively high computing capability. In this way, to accomplish high-precision image recognition on the low-cost hardware device is difficult, and the popularization efficiency of the high-precision image recognition is reduced.

In some examples, an iris recognition technology is applied to a virtual reality (VR) device. Because most segmentation algorithms employed in image segmentation operations of an iris recognition process are deployed in an embedded system, high hardware costs and complex software designs are usually required for implementing the iris segmentation. Because of this, when the iris recognition technology is deployed on the low-cost hardware device, time for performing the operation of iris segmentation is very long, and to achieve a desired real-time effect is difficult. As a result, to implement the deployment of the iris recognition technology on the low-cost hardware device is difficult, further hindering the demand for large-scale application of the iris recognition technology.

Therefore, how to improve an effect of deploying an image segmentation model on the low-cost hardware device is a problem to be urgently resolved.

### SUMMARY

This disclosure provides a method and apparatus for image segmentation, a device, a computer storage medium, and a computer program product, to improve a deployment effect of an image segmentation model on a low-cost hardware device.

Some aspects of the disclosure provide a method of quantizing an image segmentation model. In some examples, a computational power evaluation result of a device is obtained. The device is to be deployed with the image segmentation model, the computational power evaluation result indicates operational performance of the device. The image segmentation model includes a plurality of operators. At least a first operator is selected from the plurality of operators in the image segmentation model based on the computational power evaluation result, a data processing duration of the first operator on the device exceeds a threshold. At least a quantization processing is performed on the first operator based on a difference between the data processing duration of the first operator and a desired processing duration, to obtain a first quantization operator, a data processing duration of the first quantization operator on the device is less than the desired processing duration. Based on at least the first quantization operator, the image segmentation model is converted into a target model for deployment onto the device.

Some aspects of the disclosure provide an apparatus that includes processing circuitry configured to perform the method of quantizing the image segmentation model.

Some aspects of the disclosure also provide a non-transitory computer-readable storage medium storing instructions which when executed by at least one processor cause the at least one processor to perform the method of quantizing the image segmentation model.

In a first aspect, this disclosure provides a quantization method for an image segmentation model, including: obtaining a computational power evaluation result of a ready-for-deployment device and a to-be-quantized model, where the computational power evaluation result is configured for indicating operational performance of the ready-for-deployment device, and the to-be-quantized model is configured to implement the image segmentation; selecting at least one target operator from operators included in the to-be-quantized model based on the computational power evaluation result, a data processing duration of the target operator on the ready-for-deployment device reaching a set threshold; performing quantization processing on the at least one target operator based on a difference between the obtained data processing duration of the at least one target operator and a corresponding desired processing duration, to obtain a corresponding quantization operator, a data processing duration of the quantization operator on the ready-for-deployment device being less than the desired processing duration; and converting the to-be-quantized model into a corresponding target model based on the at least one quantization operator, the target model being configured for deployment onto the ready-for-deployment device.

In a second aspect, this disclosure provides a quantization apparatus for an image segmentation model. The apparatus includes: an obtaining module, configured to obtain a computational power evaluation result of a ready-for-deployment device and a to-be-quantized model, where the computational power evaluation result is configured for indicating operational performance of the ready-for-deployment device, and the to-be-quantized model is configured to implement image segmentation; a selection module, configured to select at least one target operator from operators included in the to-be-quantized model based on the computational power evaluation result, a data processing duration of the target operator on the ready-for-deployment device reaching a set threshold; and a quantization module, configured to perform quantization processing on the at least one target operator based on a difference between the obtained data processing duration of the at least one target operator and a corresponding desired processing duration, to obtain a corresponding quantization operator, a data processing duration of the quantization operator on the ready-for-deployment device being less than the desired processing duration; and convert the to-be-quantized model into a corresponding target model based on the at least one quantization operator, the target model being configured for deployment onto the ready-for-deployment device.

In a third aspect, this disclosure provides an electronic device, including a processor and a memory, where the memory has a program code stored therein, the program code, when executed by the processor, causes the processor (an example of processing circuitry) to perform the operations of any of the aforementioned quantization methods for the image segmentation model.

In a fourth aspect, this disclosure further provides a computer-readable storage medium (e.g., non-transitory computer-readable storage medium), including a computer program, when the computer program is run on an electronic device, the computer program being configured for causing the electronic device to perform the operations of any of the aforementioned quantization methods for the image segmentation model.

In a fifth aspect, this disclosure further provides a computer program product, including a computer program, the computer program, when executed by a processor, implementing the operations of any of the aforementioned quantization methods for the image segmentation model.

This disclosure has the following beneficial effects.

Embodiments of this disclosure provide the quantization method and apparatus for the image segmentation model, the device, and a storage medium. The method includes: the computational power evaluation result of the ready-for-deployment device is obtained, and an operating status of the to-be-quantized model on the ready-for-deployment device is determined according to the computational power evaluation result, whereby targeted quantization processing is performed on the operators in the to-be-quantized model, to obtain the quantization operator whose data processing duration meets a requirement. In this way, the operators are employed as quantization granularity, whereby a quantity of operations for quantizing the model is reduced, and the corresponding quantization efficiency is improved. In addition, building the corresponding target model according to these quantization operators ensures that when the target model is run on the ready-for-deployment device, a duration for processing an image segmentation task can be effectively reduced to a total desired processing duration, a deployment effect of the target model on low-cost hardware is improved, and the popularization of the image segmentation model on the low-cost device can be effectively improved.

In a model quantization process, model precision may be adjusted based on a preset precision requirement, and the model precision is adjusted to a degree matching computational power of the ready-for-deployment device, whereby the deployment effect of the target model on the ready-for-deployment device is further improved.

Other features and advantages of this disclosure are described in the following specification. Objectives and other advantages of this disclosure may be implemented and obtained through structures pointed out in the specification, claims, and accompanying drawings.

### BRIEF DESCRIPTION OF THE DRAWINGS

FIG. 1A is a schematic diagram of image segmentation according to an embodiment of this disclosure.

FIG. 1B is a schematic diagram of an application scenario according to an embodiment of this disclosure.

FIG. 2 is a flowchart of a quantization method for an image segmentation model according to an embodiment of this disclosure.

FIG. 3 is a flowchart of a method for obtaining a computational power evaluation result according to an embodiment of this disclosure.

FIG. 4 is a schematic diagram of obtaining a computational power evaluation result according to an embodiment of this disclosure.

FIG. 5 is a schematic diagram of a target operator selection method according to an embodiment of this disclosure.

FIG. 6 is a schematic diagram of another target operator selection method according to an embodiment of this disclosure.

FIG. 7 is a flowchart of a target operator selection method according to an embodiment of this disclosure.

FIG. 8 is a flowchart of a method for adjusting model precision according to an embodiment of this disclosure.

FIG. 9 is a schematic diagram of a method for adjusting model precision according to an embodiment of this disclosure.

FIG. 10A is a flowchart of a method for training a to-be-calibrated model according to an embodiment of this disclosure.

FIG. 10B is a schematic diagram of training a to-be-calibrated model according to an embodiment of this disclosure.

FIG. 11 is a flowchart of an image segmentation method according to an embodiment of this disclosure.

FIG. 12 is a schematic diagram of an image segmentation method according to an embodiment of this disclosure.

FIG. 13A is a flowchart of an image segmentation method according to an embodiment of this disclosure.

FIG. 13B is a schematic diagram of an image segmentation method according to an embodiment of this disclosure.

FIG. 14 is a flowchart of a quantization method for an image segmentation model according to an embodiment of this disclosure.

FIG. 15 is a schematic diagram of a quantization method for an image segmentation model according to an embodiment of this disclosure.

FIG. 16 is a schematic structural diagram of a quantization apparatus for an image segmentation model according to an embodiment of this disclosure.

FIG. 17 is a schematic structural diagram of hardware of an electronic device according to an embodiment of this disclosure.

FIG. 18 is a schematic structural diagram of hardware of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

In following embodiments of this disclosure, related data such as sample images are involved. When the embodiments of this disclosure are used in specific products or technologies, user permissions or agreements need to be obtained, and the collection, use, and processing of relevant data need to comply with the relevant laws, regulations, and standards of the relevant countries and regions. For example, when there is a need to obtain relevant data, relevant volunteers may be recruited and an agreement authorizing the use of data of the volunteers may be signed, whereby the data of the volunteers may be used for implementation; alternatively, implementation may be performed in an internal scope of an authorized organization, and the following embodiments are implemented by employing data of members in the organization, to perform related identification on the members in the organization; and alternatively, the related data employed during specific implementation is simulation data, for example, may be simulation data generated in a virtual scenario.

Examples of terms involved in the aspects of the disclosure are briefly introduced. The descriptions of the terms are provided as examples only and are not intended to limit the scope of the disclosure.

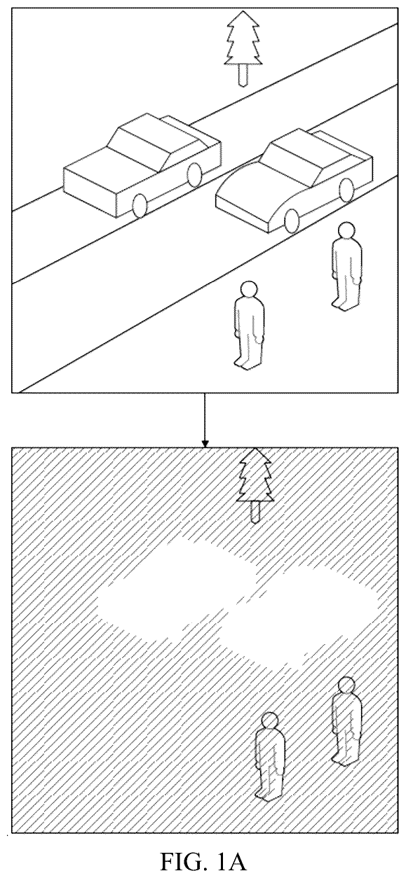

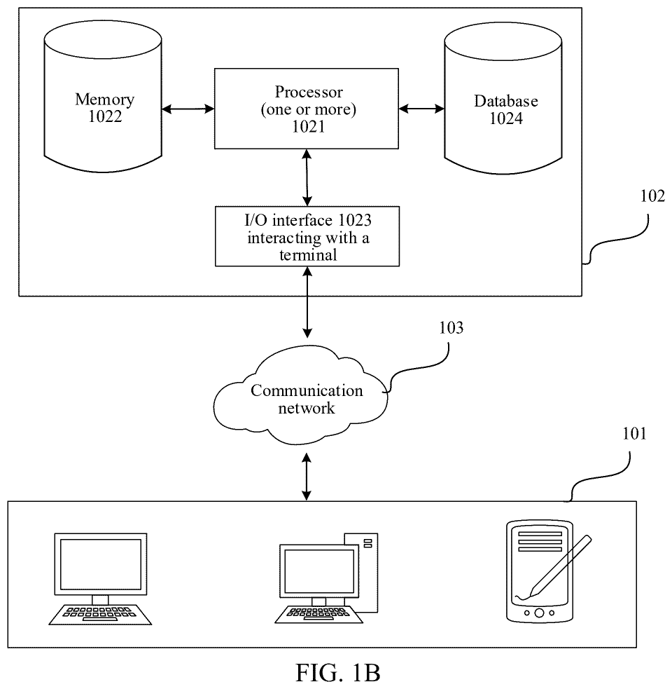

Image segmentation refers to a computer vision issue involving using some original data (e.g., a flat image) as input and converting the original data into a mask with a highlighted region of interest. As shown in FIG. 1A, when image segmentation is performed on an original image a (an upper portion of FIG. 1A) containing images of different categories, if the category to be emphasized is defined as a vehicle, after processing by an image segmentation model, an obtained image segmentation result may be shown as a segmentation result b (a lower portion of FIG. 1A) and contours of two vehicles in a panorama image are highlighted.

Operator (OP) refers to a computing unit of a deep learning algorithm. In a neural network model, an operator corresponds to computing logic in a layer, for example: a convolution layer may be an operator; and a weight summation process in a fully-connected layer (a FC layer) may alternatively be an operator.

Giga floating point operations per second (GFLOPS) is also referred to as a peak speed per second, i.e., a quantity of floating point operations run per second. A floating point refers to a value with a decimal number. A floating point operation is a quadratic operation with the decimal number, and is usually configured for measuring a computer operation speed or estimating computer performance, for example in the field of scientific computation in which a large quantity of floating point operations are used.

Floating point operations (FLOPs) can be configured for measuring complexity of a model/algorithm.

A design idea of the some embodiments of this disclosure is briefly described below.

With development of Internet technologies, more network models may achieve a technical effect of higher precision. For example, an image recognition model may recognize a target image from a plurality of images more accurately, and an image segmentation model may achieve an image segmentation effect more accurately. However, these technical effects are currently further implemented based on high hardware cost. If these network models are directly applied to low-cost hardware, achieving the desired effects is difficult.

For example, in some image recognition processes, it is necessary to first perform segmentation on an image, and then perform feature extraction on the segmented image, to implement image recognition. This process consumes excessive computational power. If the foregoing process intends to be normally implemented, hardware carrying this process is required to have a relatively high computing capability. In this way, to accomplish high-precision image recognition on the low-cost hardware device is difficult, and the popularization efficiency of the high-precision image recognition is reduced.

In some aspects, an iris recognition technology is applied to a virtual reality (VR) device. Because most segmentation algorithms employed in image segmentation operations of an iris recognition process are deployed in an embedded system, high hardware costs and complex software designs are usually required for implementing the iris segmentation. Because of this, when the iris recognition technology is deployed on the low-cost hardware device, time for performing the operation of iris segmentation is very long, and to achieve a desired real-time effect is difficult. As a result, to implement the deployment of the iris recognition technology on the low-cost hardware device is difficult, further hindering the demand for large-scale application of the iris recognition technology.

In view of this, an embodiment of this disclosure provides a quantization method for an image segmentation model, to improve a deployment effect of the image segmentation model on a low-cost hardware device.

According to the method, computational power evaluation is first performed on a ready-for-deployment device on which an image segmentation model is scheduled to be deployed, to obtain a computational power evaluation result that is configured for indicating operational performance of the ready-for-deployment device, and a to-be-quantized model that is configured to implement image segmentation. In this way, at least one target operator whose data processing duration on the ready-for-deployment device reaches a set threshold may be selected from operators included in the to-be-quantized model based on the computational power evaluation result for the ready-for-deployment device, and quantization processing is performed on the target operator based on a difference between the data processing duration of the target operator and a corresponding desired processing duration, to obtain a corresponding quantization operator. Then, the to-be-quantized model is converted into a corresponding target model according to the quantization operators. In this way, after the quantization processing is performed on the operators in the to-be-quantized model, a processing duration of the obtained target model for performing image segmentation on the ready-for-deployment device may meet a desired requirement, whereby the deployment effect of the target model on the low-cost hardware device is improved effectively.

Further, after the quantization processing is performed on the operators, a corresponding intermediate model may be built based on these quantization operators and other operators in the to-be-quantized model; and moreover, target precision corresponding to the target model is determined according to the computational power evaluation result and a corresponding total desired processing duration of the target model. In this way, the model precision corresponding to the intermediate model may be adjusted based on the target precision, causing the model precision to be the same as the target precision, whereby the target model whose processing duration for completing an image segmentation task on the ready-for-deployment device satisfies the total desired processing duration is obtained.

At the same time, after precision conversion of the intermediate model is completed, a to-be-calibrated model completing the precision conversion may further be configured in an operating environment with same hardware parameters as the ready-for-deployment device, and model parameter adjustment is performed on the to-be-calibrated model based on some sample segmentation images and sample segmentation results, whereby the adjusted target model may take both the precision and efficiency of image segmentation into consideration.

In the embodiments of this disclosure, the obtaining of the to-be-quantized model and quantization operators and the model parameter adjustment involve artificial intelligence (AI), computer vision (CV), and machine learning (ML), and are designed based on an image segmentation technology and machine learning in the AI.

The artificial intelligence involves a theory, a method, a technology, and an application system that use a digital computer or a machine controlled by the digital computer to simulate, extend, and expand human intelligence, perceive an environment, obtain knowledge, and use knowledge to obtain an optimal result. In other words, the artificial intelligence is a comprehensive technology in computer science and attempts to understand the essence of intelligence and produce a new intelligent machine that can react in a manner similar to the human intelligence. The artificial intelligence is to study the design principles and implementation methods of various intelligent machines, to enable the machines to have functions of perception, reasoning, and decision-making.

The artificial intelligence technology is a comprehensive discipline, and relates to a wide range of fields including both hardware-level technologies and software-level technologies. Basic technologies of the artificial intelligence generally include a sensor, a dedicated artificial intelligence chip, cloud computing, distributed storage, a big data processing technology, a pre-trained model technology, an operating/interaction system, electromechanical integration, and the like. The pre-trained model is also referred to as a large model or a basic model, and may be widely used in downstream tasks in various directions of the artificial intelligence after fine-tuning. The artificial intelligence software technologies mainly include several major directions such as a computer vision (CV) technology, a speech processing technology, a natural language processing technology, and machine learning/deep learning.

The computer vision is a science that studies how to use a machine to “see”, and furthermore, that uses a camera and a computer to replace human eyes to perform machine vision such as recognition, following, and measurement on a target, and further perform graphic processing, causing the computer to process the target into an image more suitable for human eyes to observe, or an image transmitted to an instrument for detection. As a scientific discipline, the computer vision studies related theories and technologies and attempts to establish an artificial intelligence system that can obtain information from images or multi-dimensional data. Large model technologies bring an important change to the development of computer vision technologies. The pre-trained model in the vision fields such as swin-transformers, vision transformer (ViT), vision-mixture of experts (V-MOE), and masked autoencoder (MAE) may be quickly and widely applied to specific downstream tasks after being fine-tuned. The computer vision technologies generally include technologies such as image processing, image recognition, image semantic understanding, image retrieval, optical character recognition (OCR), video processing, video semantic understanding, video content/behavior recognition, three-dimensional object reconstruction, a three dimensional (3D) technology, virtual reality, augmented reality, synchronous positioning, and map construction, and further include common biometric feature recognition technologies such as face recognition and fingerprint recognition.

For example, in the embodiments of this disclosure, the target model may perform image processing on a to-be-segmented iris image, to recognize a region where the iris is located from the to-be-segmented iris image.

Machine learning (ML) is a multi-field interdiscipline, and relates to a plurality of disciplines such as a probability theory, statistics, an approximation theory, convex analysis, and an algorithm complexity theory. The machine learning specializes in studying how a computer simulates or implements a human learning behavior to obtain new knowledge or skills, and reorganize an existing knowledge structure, to keep improving the performance. The machine learning is a core of the artificial intelligence, is a basic way enabling the computer to be intelligent, and is applied to various fields of the artificial intelligence. The machine learning and deep learning generally include technologies such as an artificial neural network, a belief network, reinforcement learning, transfer learning, inductive learning, and learning from demonstrations. The pre-trained model is a latest development result of deep learning, and combines the foregoing technologies.

For example, in the embodiments of this disclosure, the to-be-quantized model may be obtained in a model training manner, and the precision evaluation and parameter adjustment for the to-be-calibrated model may be implemented through a sample set.

Application scenarios of the technical solutions in the embodiments of this disclosure are briefly described below. The application scenarios described below are merely used for illustrating rather than limiting the embodiments of this disclosure. In a specific implementation process, the technical solutions provided in the embodiments of this disclosure may be used flexibly according to practical requirements.

The solutions provided by the embodiments of this disclosure may be applicable to most scenarios in which an image segmentation model is deployed, for example, applicable to a scenario of image segmentation during face recognition, and for another example, applicable to a scenario of iris segmentation during iris recognition in a VR device.

FIG. 1B is a schematic diagram of an application scenario according to an embodiment of this disclosure. The scenario may include a terminal device 101 and a server 102.

The terminal device 101 may be a device such as a mobile phone, a tablet computer (PAD), a personal computer (PC), and an in-vehicle terminal, or may be a device such as a camera, a camcorder, and a car recorder, or may be a wearable device such as VR glasses, and smart watches. The server 102 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The server 102 may include one or more processors 1021, a memory 1022, an input/output (I/O) interface 1023 interacting with a terminal, and the like. In addition, the server 102 may further be configured with a database 1024. The database 1024 may be configured to store a to-be-segmented image, an image segmentation result, a sample set, model parameters of a to-be-quantized model, model parameters of a target model, and the like. The memory 1022 of the server 102 may further store program instructions of an image model quantization method provided by the embodiments of this disclosure. The program instructions, when executed by the processor 1021, can be configured to implement operations of the image model quantization method provided by the embodiments of this disclosure, to obtain the target model, the image segmentation result, and the like. The target model may be deployed or an effect of the target model may be displayed on the terminal device 101.

The terminal device 101 may be in communication connection with the server 102 directly or indirectly by using one or more communication networks 103. The communication network 103 may be a wired network or a wireless network. For example, the wireless network may be a mobile cellular network, or may be a wireless-fidelity (Wi-Fi) network, and may be other suitable networks. This is not limited in the embodiments of this disclosure.

In addition, an image model quantization method according to the embodiments of this disclosure may be performed by a computer device. The computer device may be the terminal device 101 or the server 102, namely, the method may be performed by the terminal device 101 or the server 102 alone, or may be performed collectively by the terminal device 101 and the server 102.

For example, when the method is performed by the server 102 alone, the server 102 may obtain a corresponding to-be-quantized model and a computational power evaluation result of a ready-for-deployment device, to select a target operator from the to-be-quantized model based on the to-be-quantized model and the computational power evaluation result, and quantize the target operator, to obtain a target model.

For another example, when the method is performed by the terminal device 101 alone, there may be two cases in which the terminal device is the ready-for-deployment device and the terminal device is not the ready-for-deployment device. In this way, when the method is performed by the terminal, the method may be divided into two cases: directly obtaining a computational power evaluation result of the terminal device and obtaining the computational power evaluation result of the terminal device from another terminal device, and another execution method is similar to that performed by the server.

For another example, the method may further be jointly performed by the terminal device 101 and the server 102. The terminal device may provide the sample set, the to-be-segmented image, or the computational power evaluation result to the server. The server may perform quantization processing on the target operator in the to-be-quantized model according to the obtained computational power evaluation result and the to-be-quantized model, to obtain the corresponding target model.

In addition, FIG. 1B is merely an example for description. Actually, a quantity and communication mode of the terminal device and server are not limited and are not limited in the embodiments of this disclosure.

A quantization method for the image segmentation model provided by examples of implementations of this disclosure is described below with reference to the foregoing described application scenarios and the accompanying drawings. The foregoing application scenarios are merely shown for ease of understanding the spirit and principle of this disclosure, and the implementations of this disclosure are not limited in this aspect.

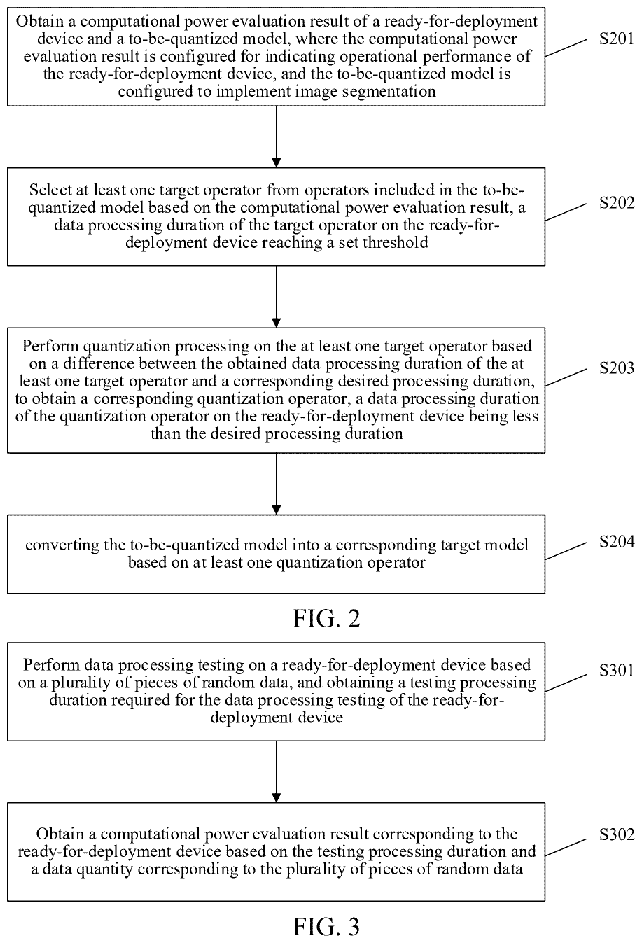

FIG. 2 is a flowchart of a quantization method for an image segmentation model according to an embodiment of this disclosure. The method may be performed by the foregoing computer device. In the present embodiment, for ease of description, an example in which the computer device is the server is used. The method includes the following operations.

S201: Obtain a computational power evaluation result of a ready-for-deployment device and a to-be-quantized model, where the computational power evaluation result is configured for indicating operational performance of the ready-for-deployment device, and the to-be-quantized model is configured to implement image segmentation.

In some aspects, when performing the quantization method for the image segmentation model, the server first needs to obtain a to-be-quantized image segmentation model (abbreviated as the to-be-quantized model below) and the computational power evaluation result of a device (a ready-for-deployment device) on which the to-be-quantized model is to be deployed. The to-be-quantized model may be obtained in the following several different manners.

For example, before performing the quantization method, the server may directly perform training based on a convolution neural network to obtain an image segmentation model capable of performing image segmentation as the subsequent to-be-quantized model. In a training process of the image segmentation model, a model convergence condition may be set according to a user requirement. This is not limited in this disclosure. After the model training, the obtained image segmentation model may be directly used for the image segmentation, and the image segmentation precision and efficiency of the image segmentation model may further achieve an optimal result. However, this effect is achieved on the premise that the image segmentation model is operated on a relatively high-cost hardware device. If the image segmentation model is desired to effectively run on low-cost hardware, the server needs to perform the quantization method for the image segmentation model according to the embodiment of this disclosure on the image segmentation model.

For another example, the server may directly obtain some image segmentation models that are already trained, and if it is determined that these trained models capable of directly performing the image segmentation still take a long time on the low-cost hardware, the server may perform the quantization method for the image segmentation model provided by the embodiment of this disclosure.

After the image segmentation model is obtained in the foregoing different manners, a quantization method needs to be performed on the image segmentation model, and these image segmentation models are briefly referred to as to-be-quantized models.

Because different devices correspond to different hardware parameters, if the to-be-quantized model is desired to have good performance on different ready-for-deployment devices, the server needs to perform different quantization processing on the to-be-quantized model for the hardware parameters of the different ready-for-deployment devices, whereby a good technical effect can be achieved on different devices. By taking a ready-for-deployment device as an example, the following describes how to perform quantization processing on the to-be-quantized model for the ready-for-deployment device.

After obtaining the to-be-quantized model, the server needs to evaluate an operational capability of the ready-for-deployment device.

In some embodiments, when the computational power evaluation result of a ready-for-deployment device is obtained, the processing method shown in FIG. 3 may be performed on the ready-for-deployment device.

FIG. 3 is a flowchart of a method for obtaining a computational power evaluation result according to an embodiment of this disclosure. As shown in FIG. 3, the method includes the following operations.

S301: Perform data processing testing on a ready-for-deployment device based on a plurality of pieces of random data, and obtain a testing processing duration required for the data processing testing of the ready-for-deployment device.

S302: Obtain a computational power evaluation result corresponding to the ready-for-deployment device based on the testing processing duration and a data quantity corresponding to the plurality of pieces of random data.

In some aspects, when the server needs to perform computational power testing on the ready-for-deployment device, what needs to be tested is mainly computational power of a processor employed by the hardware device for data computation. The processor may include at least one of a central processing unit (CPU) and a graphics processing unit (GPU). A specific testing target is to obtain a quantity of floating point operations per second of the ready-for-deployment device.

Based on this, when obtaining the computational power evaluation result, the server may perform the data processing testing in a form of matrix multiplication. The matrix multiplication is a relatively common mathematical operation, and may be applied to fields such as image processing, signal processing, and machine learning. Because a computational quantity of the matrix multiplication increases greatly with the expansion of a matrix, the matrix multiplication may be employed to test floating point operational performance of the CPU.

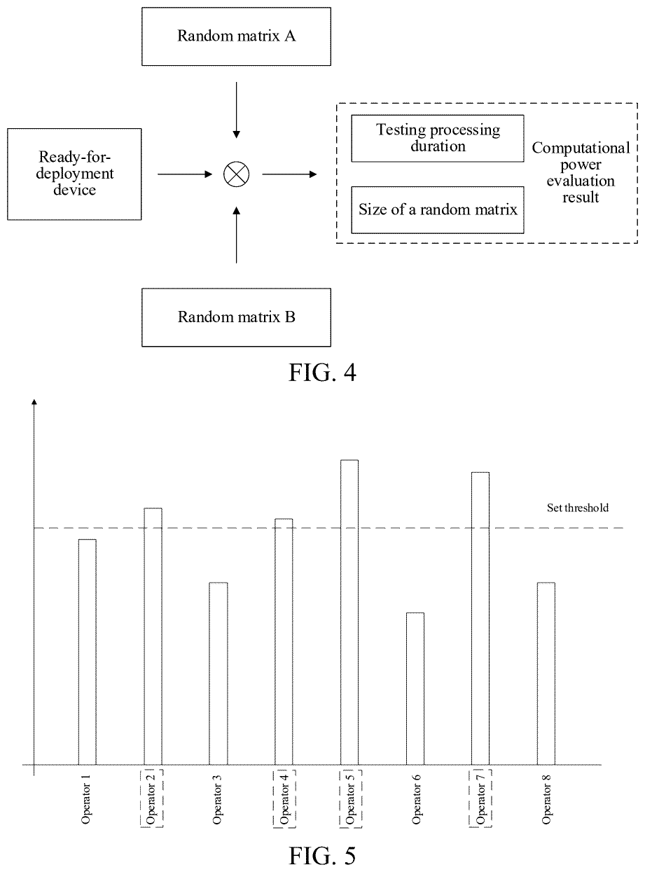

For example, as shown in FIG. 4, when data processing testing is performed on a ready-for-deployment device, two random matrices with different sizes may be first generated. The sizes of the two random matrices may be preset sizes, or may be sizes generated in different manners. This is not limited in this disclosure, and the server only needs to record the corresponding sizes of the two random matrices.

Assuming that the two random matrices are a random matrix A and a random matrix B, after obtaining the two matrices, the server may perform a multiplication operation on the random matrix A and the random matrix B based on a hardware environment of the ready-for-deployment device, to obtain a matrix C.

In addition, the matrix operation based on the hardware environment of the ready-for-deployment device may be performed in two manners. One may be that the server directly instructs the ready-for-deployment device to perform the matrix operation, to obtain the corresponding matrix C and collect related computation data. In this way, the server may collect related operational performance of the ready-for-deployment device, and obtain a more accurate computational power evaluation result.

Alternatively, the server may simulate the ready-for-deployment device inside the server based on the hardware parameters of the ready-for-deployment device, whereby the matrix multiplication computation related to the ready-for-deployment device is performed directly inside the server, to obtain related computation data. In this way, the data processing testing for the ready-for-deployment device is not limited to a specific ready-for-deployment device, and the server may directly obtain a relatively universal computational power evaluation result for the ready-for-deployment device, whereby the overall evaluation result of the ready-for-deployment device may not be affected by a defect of an individual ready-for-deployment device.

While obtaining the generated matrix C, the server further needs to collect a computation duration of the matrix multiplication, enabling the server to compute a quantity of floating point operations per second of the ready-for-deployment device according to the sizes of the random matrix A and random matrix B, and a total testing processing duration for the ready-for-deployment device to complete the matrix computation. Then, the server may use the quantity of floating point operations per second as the corresponding computational power evaluation result of the ready-for-deployment device.

In some embodiments, to avoid the particularity of the randomly generated matrix, when the data processing testing is performed on the ready-for-deployment device, the testing times for the ready-for-deployment device may be properly increased, and after arithmetic averaging or other statistical processing is performed on results of the multiple tests, an obtained statistical result is taken as the corresponding computational power evaluation result of the ready-for-deployment device. In this way, negative impact caused by accidental results is avoided.

The operation capability of the ready-for-deployment device is tested, and after the computational power evaluation result of the ready-for-deployment device is obtained, the server may limit a quantization direction of the to-be-quantized model based on the computational power evaluation result.

S202: Select at least one target operator from operators included in the to-be-quantized model based on the computational power evaluation result, a data processing duration of the target operator on the ready-for-deployment device reaching a set threshold.

Operation units included in the to-be-quantized model are the operators described in S202. Therefore, for a model, different operators consume different computation amounts during the operation.

Based on this, for the GFLOPS that may be provided by the ready-for-deployment device, durations for different operators to complete the data processing on the same ready-for-deployment device may be different, and a total data processing duration consumed by these operators is a processing duration required by the whole to-be-quantized model to complete one image segmentation processing on the ready-for-deployment device.

Therefore, when the total data processing duration of a to-be-quantized model needs to be greater than a total desired processing duration set by a developer, the server needs to perform targeted processing on different operators included in the to-be-quantized model.

For example, as shown in FIG. 5, the server may separately perform statistical collection on the corresponding data processing durations of the operators when completing the data processing on the ready-for-deployment device, then select the target operator whose total data processing duration is greater than a set threshold based on a plurality of data processing durations, and perform quantization processing on these target operators.

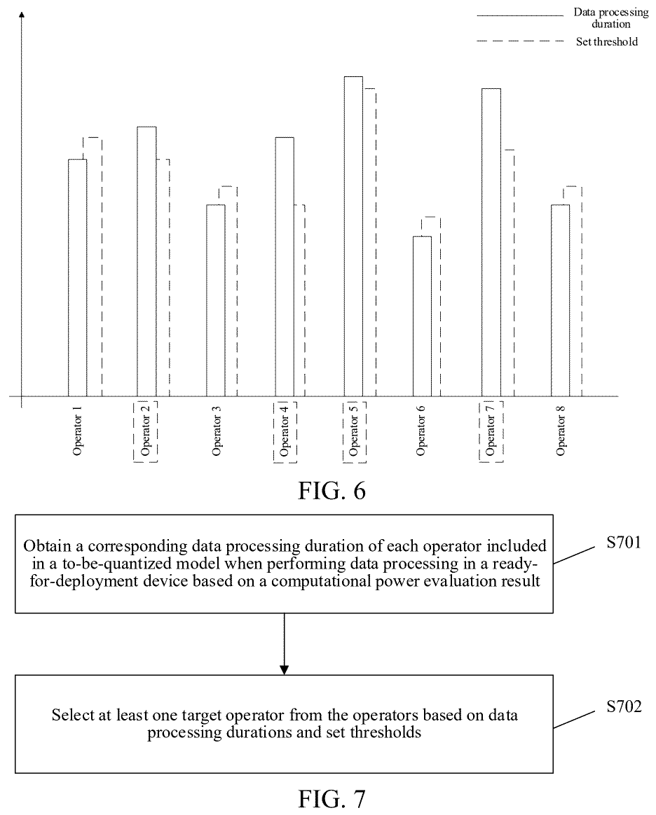

For another example, as shown in FIG. 6, the server may separately set a desired processing duration for each operator included in the to-be-quantized model. In this way, when there are operators whose data processing duration on the ready-for-deployment device exceeds the corresponding set threshold, the server may select the target operators whose data processing durations exceed the corresponding desired processing durations from the plurality of operators, and perform the quantization processing on these target operators.

In some aspects, the server may select the target operator by performing a selection method shown in FIG. 7. FIG. 7 is a flowchart of a target operator selection method according to an embodiment of this disclosure. As shown in FIG. 7, the method includes the following operations.

S701: Obtain a corresponding data processing duration of each operator included in the to-be-quantized model when performing data processing in a ready-for-deployment device based on a computational power evaluation result.

The server may directly compute the data processing duration required by each operator according to the computational power evaluation result (i.e., the quantity of floating point operations per second) of the ready-for-deployment device and the computation amount required by each operator included in the to-be-quantized model for performing the computation. Alternatively, the server may perform a simulation operation in the server according to the computational power evaluation result of the ready-for-deployment device, and directly collect the corresponding data processing duration of each operator included in the to-be-quantized model. This is not limited in this disclosure.

S702: Select at least one target operator from the operators based on the data processing durations and set thresholds.

The set threshold may be separately configured for each operator by the developer based on a desired processing duration, or may be directly allocated by the server to each operator in the to-be-quantized model based on the total desired processing duration desired by the developer. This is not limited in this disclosure.

After obtaining the corresponding data processing durations of the operators and the corresponding set thresholds, the server may select at least one target operator whose data processing duration exceeds the corresponding set threshold from the operators.

Through the foregoing manner, the operator whose data processing duration is excessively long may be determined from the to-be-quantized model as the target operator. In this way, by quantizing these operators, the computation time of the to-be-quantized model on the ready-for-deployment device may be effectively reduced, and the quantization efficiency may be improved.

After selecting the target operators, the server may perform the following operations on these target operators:

S203: Perform quantization processing on the at least one target operator based on a difference between the obtained data processing duration of the at least one target operator and the corresponding desired processing duration, to obtain the corresponding quantization operator, a data processing duration of the quantization operator on the ready-for-deployment device being less than the desired processing duration.

The quantization processing is a technology in which parameters (such as a convolution kernel, an activation function, or a pooling layer) related to the target operator in the to-be-quantized model are converted into an expression form that can be easier for value computation. By means of the quantization processing, the computation efficiency and accuracy of the target operator in the to-be-quantized model can be improved. In some aspects, the quantization processing is to quantize the parameters in the target operator, and convert the parameters into a form of an 8-bit unsigned integer (such as 0 or 1), to facilitate subsequent computation and processing.

In addition, a value of the desired processing duration proposed in S203 may be equal to a value of the set threshold in S202. In this way, a quantization operator obtained after quantization processing may be prevented from being re-determined as the target operator in a subsequent re-selection process. Alternatively, the corresponding value of the desired processing duration may be less than the corresponding value of the set threshold. In this way, the duration for the quantization operator obtained after the quantization processing to complete the data processing is shorter, and a total duration for the whole model to complete the image segmentation process may further be shorter. In this way, the deployment effect of the image segmentation model on the low-cost hardware device is further improved.

In some embodiments, when performing the quantization processing on the target operators, the server may further employ the following manner to achieve a quantization effect on the target operators.

In some aspects, the server may obtain the quantization parameters corresponding to the at least one target operator based on the difference between the obtained data processing duration of the at least one target operator and the corresponding desired processing duration.

The quantization parameters corresponding to the target operator may include parameters such as a quantization factor or a bias value. In this way, the quantization processing performed on the target operator may be to adjust some parameters in the target operator, whereby the duration for the target operator to complete the data processing is less than the desired processing duration.

Alternatively, the quantization processing performed on the target operator may be to replace the target operator with an operator with a distinct structure but the same function, whereby the duration for the replacement operator to complete the operation performed by the target operator meets the requirement of the desired processing duration.

Then, the quantization processing is performed on the at least one target operator based on these quantization parameters and precision corresponding to the at least one target operator to obtain the corresponding quantization precision; and a deviation between the precision corresponding to the quantization operator and the precision corresponding to the target operator is less than a preset range.

Different quantization methods may be selected for performing the quantization processing on the target operator, such as a linear quantization method, a non-linear quantization method, or a symmetric quantization method. This is not limited in this disclosure, provided that in a quantization process, the deviation between the precision of the quantization operator and the precision of the target operator is less than the preset range. The definition of the preset range may be directly determined by the developer, or may be configured by the server according to the parameters obtained in the training process.

According to the quantization parameters determined according to the required duration reduction, the targeted duration-reduced quantization processing may be performed on the target operator, while maintaining the computation precision of the target operator, to achieve high-quality quantization.

S204: Convert the to-be-quantized model into a corresponding target model based on the at least one quantization operator.

After obtaining the foregoing quantization operator, the server may perform stream processing on the to-be-quantized model according to the obtained quantization operator, to convert the to-be-quantized model into the corresponding target model.

The target model obtained by conversion may be deployed to the ready-for-deployment device.

In the present solution, the computational power testing is performed on the ready-for-deployment device, to obtain the corresponding computational power evaluation result, and an operating status of the to-be-quantized model on the ready-for-deployment device is determined based on the computational power evaluation result, whereby the targeted quantization processing is performed on the operators in the to-be-quantized model, to obtain the corresponding target model. Therefore, the operation duration of the target model on the ready-for-deployment device is reduced, the deployment effect of the target model on the ready-for-deployment device is improved, and the popularization difficulty of the target model is reduced.

In some embodiments, when converting the to-be-quantized model into the corresponding target model based on the quantization operator, the server may perform the following operations, to further reduce the processing duration required by the target model to perform the image segmentation on the ready-for-deployment device.

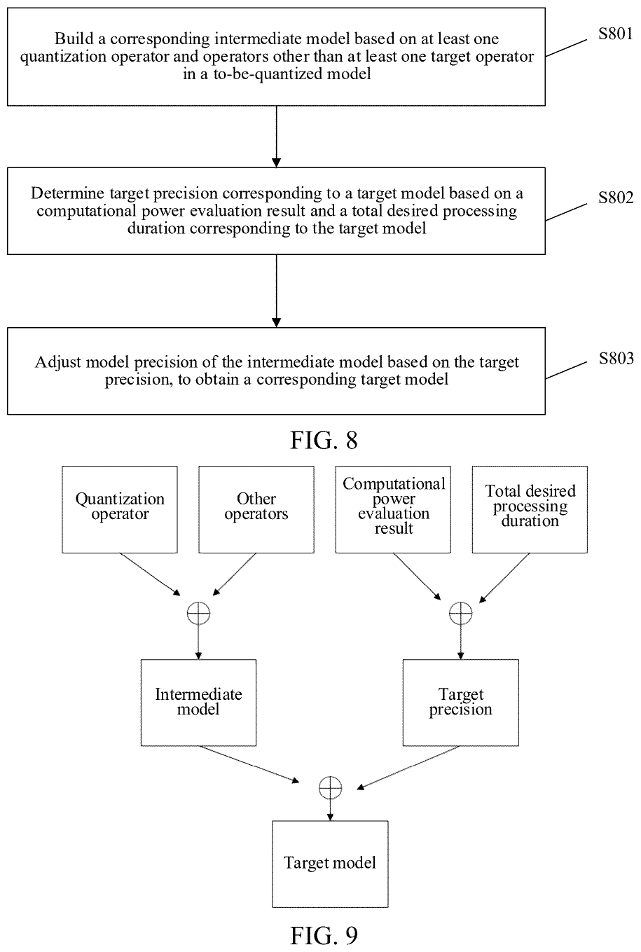

FIG. 8 is a flowchart of a method for adjusting a model precision according to an embodiment of this disclosure. As shown in FIG. 8, the method includes the following operations.

S801: Build a corresponding intermediate model based on at least one quantization operator and operators other than at least one target operator in a to-be-quantized model.

After completing quantization processing on a target operator, the server may build the intermediate model jointly from the obtained quantization operators and initial quantization operators whose data processing duration does not exceed the corresponding set threshold in the to-be-quantized model.

To further reduce the time for a target model to process the image segmentation on the ready-for-deployment device, the server may further reduce the model precision corresponding to the model (such as reducing the precision of data processed by the model), to reduce a quantity of operations when the model performs image segmentation, whereby the data processing duration of the model is reduced.

S802: Determine target precision corresponding to the target model based on a computational power evaluation result and a total desired processing duration corresponding to the target model.

S803: Adjust model precision of the intermediate model based on the target precision, to obtain the corresponding target model.

In some aspects, as shown in FIG. 9, the server needs to first determine the model precision desired to be achieved by the target model, and the determining process may be determined according to the computational power evaluation result corresponding to the ready-for-deployment device and the total desired processing duration corresponding to the target model.

For example, it is determined whether the operational performance of the ready-for-deployment device is so insufficient that if the total data processing duration of the target model is desired to reach the corresponding total desired processing duration, it is necessary to convert the original floating point (FP) 32 precision to integer number (INT) 8 precision. For another example, when it is determined that computational power of the ready-for-deployment device is sufficient to enable the ready-for-deployment device to complete the high-precision data processing within the total desired processing duration, the server may convert the original model precision (FP32 precision) into the FP16 precision. In this way, while the computational precision is reserved, the operational performance of the ready-for-deployment device may further be fully used, and the probability of performance vacancy is reduced.

In some embodiments, after the precision of the intermediate model is adjusted, the server may further perform model training based on the to-be-calibrated model after the precision adjustment, to give consideration to both the precision and the time consumption when the target model performs image segmentation on the ready-for-deployment device.

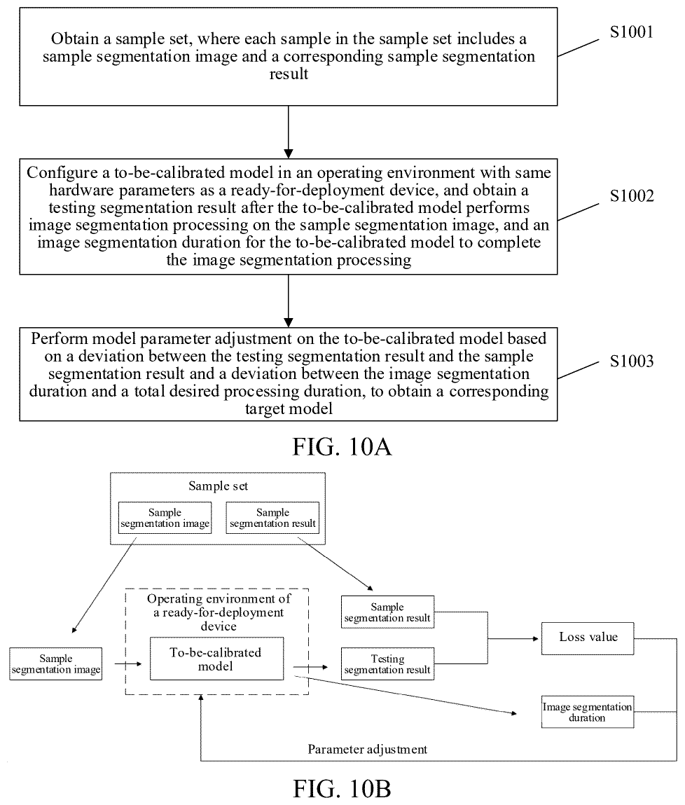

FIG. 10A is a flowchart of a method for training a to-be-calibrated model according to an embodiment of this disclosure. As shown in FIG. 10A, the method includes the following operations.

S1001: Obtain a sample set, where each sample in the sample set includes a sample segmentation image and a corresponding sample segmentation result.

The sample segmentation result corresponding to the sample segmentation image in the sample set may be obtained after the to-be-quantized model performs the image segmentation. In this way, during subsequent training, the sample segmentation result is used as a label for training, whereby the image segmentation result obtained by a trained to-be-calibrated model may correspond to an initial segmentation result of the to-be-quantized model to the greatest extent.

S1002: Configure the to-be-calibrated model in an operating environment with same hardware parameters as a ready-for-deployment device, and obtain a testing segmentation result obtained after the to-be-calibrated model performs image segmentation processing on the sample segmentation image, and an image segmentation duration for the to-be-calibrated model to complete the image segmentation processing.

Before the to-be-calibrated model is trained, the to-be-calibrated model first needs to be configured in the operating environment with the same hardware parameters as the ready-for-deployment device. To ensure convergence efficiency of the model training, the server may automatically create a simulation environment to be the same as the operating environment of the ready-for-deployment device, and then train the to-be-calibrated model in the simulation environment, whereby the to-be-calibrated model performs segmentation processing on the sample segmentation image, to obtain the corresponding testing segmentation result, and simultaneously obtain the corresponding image segmentation duration for the to-be-calibrated model to complete the image segmentation processing.

S1003: Perform model parameter adjustment on the to-be-calibrated model based on a deviation between the testing segmentation result and the sample segmentation result and a deviation between the image segmentation duration and a total desired processing duration, to obtain the corresponding target model.

As shown in FIG. 10B, in a round of training process, the server may perform model parameter adjustment on the to-be-calibrated model according to a loss value between the obtained testing segmentation result corresponding to a sample segmentation image and the sample segmentation result, and the deviation between the image segmentation duration taken by the to-be-calibrated model when processing the sample segmentation image and the total desired processing duration corresponding to the to-be-calibrated model, to complete a round of training for the to-be-calibrated model.

In this way, after a plurality of rounds of foregoing training, the server may obtain the target model that can take both the image segmentation precision and the image segmentation efficiency into consideration.

The process of obtaining the target model is described above. After obtaining the target model, the server may employ the target model to complete the deployment of the target model on the ready-for-deployment device and the image processing. For example, the server may deploy the target model in a VR device, to be applied to an iris segmentation process during iris recognition. Alternatively, the server may deploy the target model in a low-cost mobile phone, to implement a face image segmentation process during face recognition.

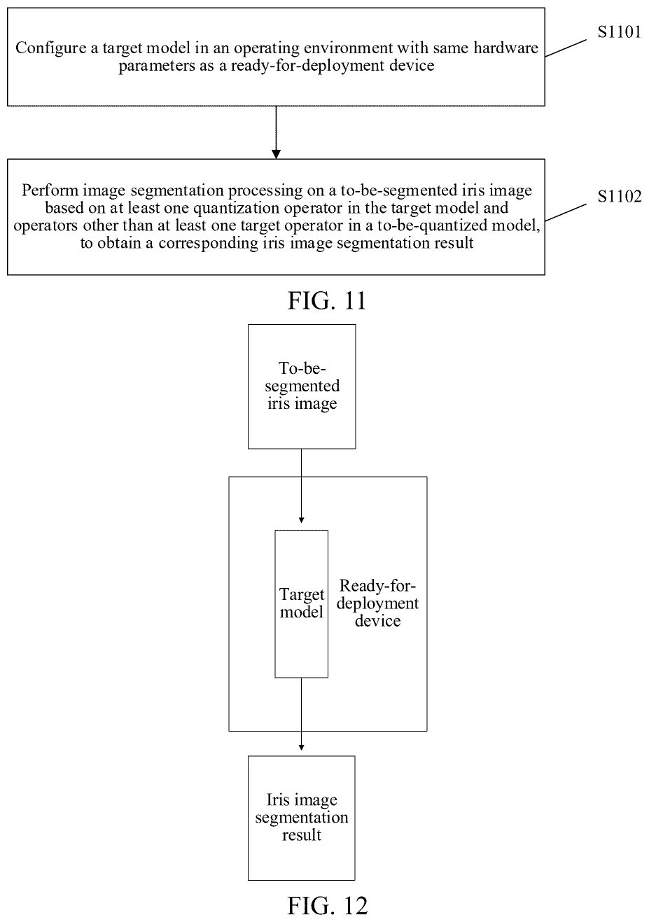

FIG. 11 is a flowchart of an image segmentation method according to an embodiment of this disclosure. The method includes the following operations.

S1101: Configure a target model in an operating environment with same hardware parameters as a ready-for-deployment device.

In addition, when the target model is deployed, an object for the target model to be deployed is not limited to only one device of the ready-for-deployment object, but may be deployed in another device with the same hardware parameters as the ready-for-deployment object, or may be directly deployed in the virtual machine. This is not limited in this disclosure.

S1102: Perform image segmentation processing on a to-be-segmented iris image based on at least one quantization operator in the target model and operators other than at least one target operator in the to-be-quantized model after the server deploys the target model, to obtain a corresponding iris image segmentation result.

As shown in FIG. 12, after the target model is deployed, when performing the segmentation processing on an iris image, the target model may perform the image segmentation processing on the to-be-segmented iris image based on the quantization operator after the quantization processing included in the target model and other operators without the need of quantification processing than the target operator, to obtain the corresponding iris image segmentation result.

In this way, the processing duration of performing the iris image segmentation on the ready-for-deployment device is reduced, and an implementation effect of iris recognition on the low-cost device is ensured. Therefore, the iris recognition technology may be popularized to the low-cost hardware device.

To further reduce the processing duration of the iris image segmentation, the precision of the target model may further be preset precision. In this case, the preset precision may be the INT8 precision or the FP16 precision as described above. In this way, when the target model with this precision performs the image segmentation, the required processing duration may be further reduced.

However, to match the model precision, for an image inputted into the target model, adaptive precision adjustment may further be performed on the image in advance, to ensure that data inputted into the model matches the model precision.

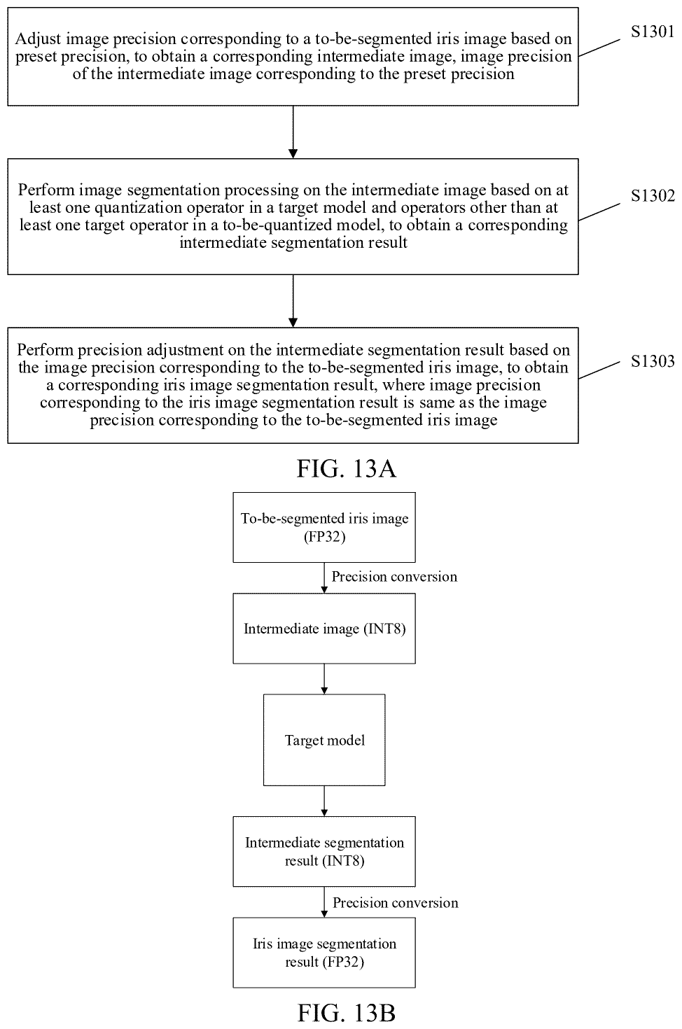

FIG. 13A is a flowchart of an image segmentation method according to an embodiment of this disclosure. As shown in FIG. 13A, the method includes the following operations.

S1301: Adjust image precision corresponding to a to-be-segmented iris image based on preset precision, to obtain a corresponding intermediate image, the image precision of the intermediate image corresponding to the preset precision.

The preset precision is the model precision corresponding to the target model. Therefore, when the preset precision is INT8, the server needs to adjust the image precision of the to-be-segmented iris image to the corresponding precision of INT8 from the precision of FP32 or FP16. Only in this way, the image precision may be inputted into the target model for image segmentation.

S1302: Perform image segmentation processing on the intermediate image based on at least one quantization operator in the target model and operators other than at least one target operator in the to-be-quantized model, to obtain a corresponding intermediate segmentation result.

In this case, after the target model with the preset precision performs the image segmentation processing on the to-be-segmented iris image with the preset precision, the precision of the obtained intermediate segmentation result is further the preset precision. However, the intermediate segmentation result with the preset precision cannot be directly used as the image segmentation result corresponding to the initial to-be-segmented iris image with high precision due to mismatching of the image precision. Therefore, the server needs to further perform the following operations to output a final iris image segmentation result.

S1303: Perform precision adjustment on an intermediate segmentation result based on the image precision corresponding to the to-be-segmented iris image, to obtain the corresponding iris image segmentation result, where the image precision corresponding to the iris image segmentation result is the same as the image precision corresponding to the to-be-segmented iris image.

After the target model completes the low-precision segmentation processing on the to-be-segmented image, the server may further perform inverse quantization processing on an obtained low-precision intermediate segmentation result, for example, a result with low precision of INT8 may be inversely quantized into a result with the precision of FP32 or FP16. In this way, the precision and readability of the iris image segmentation result may be improved, and the precision requirement for the subsequent image processing may be met, whereby the implementability of the present solution is improved.

As shown in FIG. 13B, precision conversion may be first performed on the to-be-segmented iris image with the image precision of FP32, to obtain the intermediate image with the image precision of INT8, the intermediate image is inputted to the target model to obtain the corresponding intermediate segmentation result with the precision of INT8, and finally the intermediate segmentation result with the precision of INT8 is converted into the iris image segmentation result with the precision of FP32.

The quantization process for the image model provided by the embodiments of this disclosure and some implementations are described above. The quantization process is described below by combining the foregoing solutions in a manner.

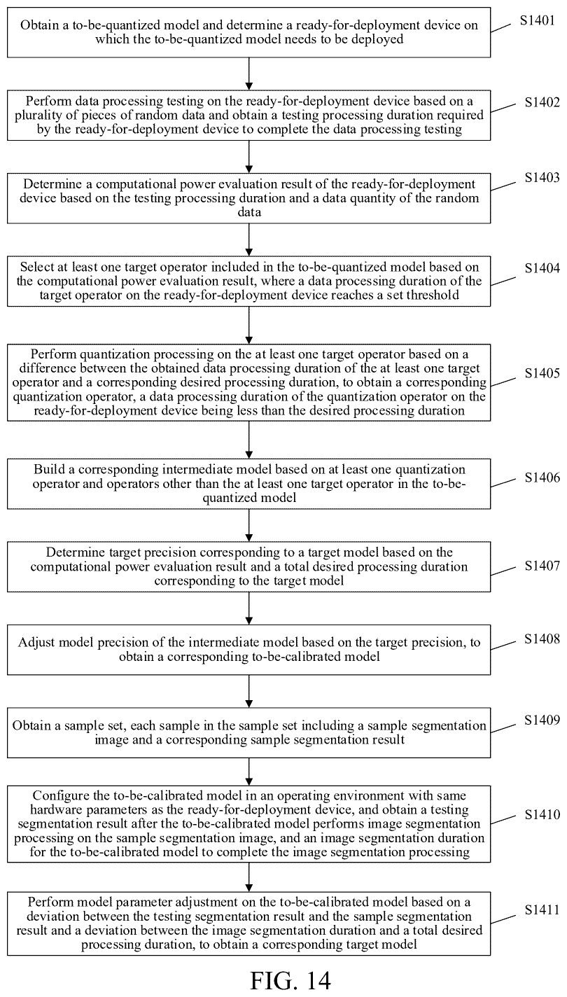

FIG. 14 is a flowchart of a quantization method for an image segmentation model according to an embodiment of this disclosure. The method includes the following operations.

S1401: Obtain a to-be-quantized model and determine a ready-for-deployment device on which the to-be-quantized model needs to be deployed.

S1402: Perform data processing testing on the ready-for-deployment device based on a plurality of pieces of random data and obtain a testing processing duration required by the ready-for-deployment device to complete the data processing testing.

S1403: Determine a computational power evaluation result of the ready-for-deployment device based on the testing processing duration and a data quantity of the random data.

S1404: Select at least one target operator included in the to-be-quantized model based on the computational power evaluation result, where a data processing duration of the target operator on the ready-for-deployment device reaches a set threshold.

S1405: Perform quantization processing on the at least one target operator based on a difference between the obtained data processing duration of the at least one target operator and a corresponding desired processing duration, to obtain a corresponding quantization operator, a data processing duration of the quantization operator on the ready-for-deployment device being less than the desired processing duration.

S1406: Build a corresponding intermediate model based on the at least one quantization operator and the operators other than the at least one target operator in the to-be-quantized model.

S1407: Determine target precision corresponding to a target model based on the computational power evaluation result and a total desired processing duration corresponding to the target model.

S1408: Adjust model precision of the intermediate model based on the target precision, to obtain a corresponding to-be-calibrated model.

S1409: Obtain a sample set, each sample in the sample set including a sample segmentation image and a corresponding sample segmentation result.

S1410: Configure the to-be-calibrated model in an operating environment with same hardware parameters as the ready-for-deployment device, and obtain a testing segmentation result obtained after the to-be-calibrated model performs image segmentation processing on the sample segmentation image, and an image segmentation duration for the to-be-calibrated model to complete the image segmentation processing.

S1411: Perform model parameter adjustment on the to-be-calibrated model based on a deviation between the testing segmentation result and the sample segmentation result and a deviation between the image segmentation duration and a total desired processing duration, to obtain the corresponding target model.

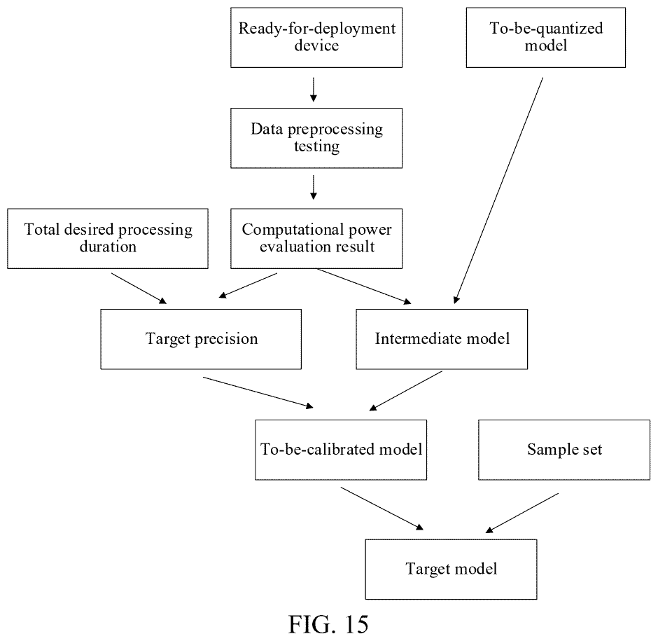

As shown in FIG. 15, after obtaining the target model, the server may further deploy the target model in the ready-for-deployment device to complete the image segmentation process of the corresponding iris image.

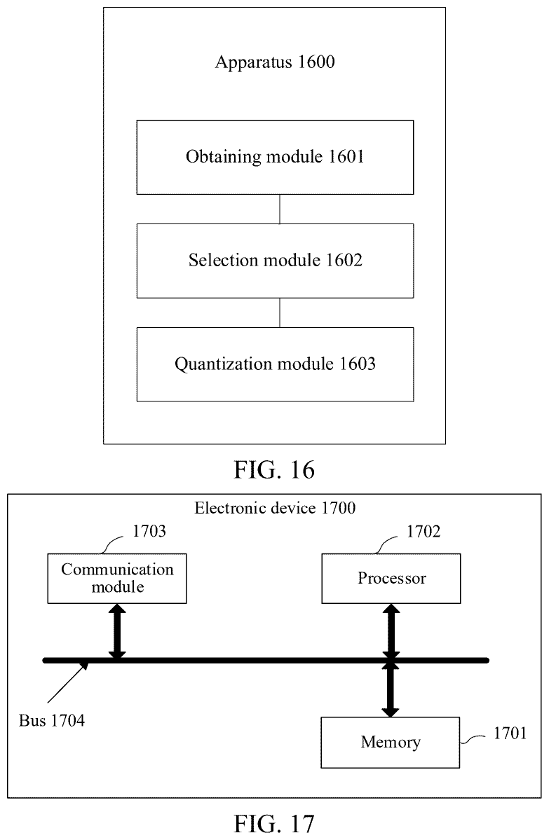

Based on a same invention concept, an embodiment of this disclosure further provides a quantization apparatus for an image segmentation model. FIG. 16 is a schematic structural diagram of a quantization apparatus for an image segmentation model according to an embodiment of this disclosure. The apparatus may be the foregoing terminal device or server, or a chip or an integrated circuit therein. The apparatus includes a module/unit/technical means configured to perform the method performed by the terminal device or the server in the foregoing method embodiments.

For example, the apparatus 1600 includes:
an obtaining module 1601, configured to obtain a computational power evaluation result of a ready-for-deployment device and a to-be-quantized model, where the computational power evaluation result is configured for indicating operational performance of the ready-for-deployment device, and the to-be-quantized model is configured to implement image segmentation;
a selection module 1602, configured to select at least one target operator from operators included in the to-be-quantized model based on the computational power evaluation result, a data processing duration of the target operator on the ready-for-deployment device reaching a set threshold; and
a quantization module 1603, configured to perform quantization processing on the at least one target operator based on a difference between the obtained data processing duration of the at least one target operator and a corresponding desired processing duration, to obtain a corresponding quantization operator, a data processing duration of the quantization operator on the ready-for-deployment device being less than the desired processing duration, and convert the to-be-quantized model into a corresponding target model based on at least one quantization operator, the target model being configured for deployment onto the ready-for-deployment device.

In an implementation, when configured to convert the to-be-quantized model into the corresponding target model based on the at least one quantization operator, the quantization module 1603 is configured to:
build a corresponding intermediate model based on the at least one quantization operator and the operators other than the at least one target operator in the to-be-quantized model; and
determine target precision corresponding to the target model based on the computational power evaluation result and a total desired processing duration corresponding to the target model; and
adjust model precision of the intermediate model based on the target precision, to obtain the corresponding target model.

In an implementation, when configured to adjust the model precision of the intermediate model based on the target precision, to obtain the corresponding target model, the quantization module 1603 is configured to:
adjust the model precision of the intermediate model based on the target precision, to obtain a corresponding to-be-calibrated model,
obtain a sample set, each sample in the sample set including a sample segmentation image and a corresponding sample segmentation result,
configure the to-be-calibrated model in an operating environment with same hardware parameters as the ready-for-deployment device, and obtain a testing segmentation result after the to-be-calibrated model performs image segmentation processing on the sample segmentation image, and an image segmentation duration for the to-be-calibrated model to complete the image segmentation processing, and
perform model parameter adjustment on the to-be-calibrated model based on a deviation between the testing segmentation result and the sample segmentation result and a deviation between the image segmentation duration and the total desired processing duration, to obtain the corresponding target model.

In an implementation, when configured to obtain the computational power evaluation result of the ready-for-deployment device, the obtaining module 1601 is configured to:
perform data processing testing on the ready-for-deployment device based on a plurality of pieces of random data, and obtain a testing processing duration required for the data processing testing of the ready-for-deployment device, and
obtain the computational power evaluation result corresponding to the ready-for-deployment device based on the testing processing duration and a data quantity corresponding to the plurality of pieces of random data.

In an implementation, when configured to select the at least one target operator from the operators included in the to-be-quantized model based on the computational power evaluation result, the selection module 1602 is configured to:
obtain a corresponding data processing duration of each operator included in the to-be-quantized model when performing data processing in the ready-for-deployment device based on the computational power evaluation result, and
select the at least one target operator from the operators based on the data processing durations and set thresholds.

In an implementation, when configured to perform the quantization processing on the at least one target operator based on a difference between the obtained data processing duration of the at least one target operator and the corresponding desired processing duration, to obtain the corresponding quantization operator, the quantization module 1603 is configured to:
obtain quantization parameters corresponding to the at least one target operator based on the difference between the obtained data processing duration of the at least one target operator and the corresponding desired processing duration, and
perform the quantization processing on the at least one target operator based on the quantization parameters and precision corresponding to the at least one target operator, to obtain the corresponding quantization operator, where a deviation between the precision corresponding to the quantization operator and the precision corresponding to the target operator is less than a preset range.

In an implementation, the apparatus 1600 further includes a processing module 1604, and after obtaining the target model, the processing module 1604 is configured to:
configure the target model in an operating environment with same hardware parameters as the ready-for-deployment device, and
perform image segmentation processing on a to-be-segmented iris image based on the at least one quantization operator in the target model and the operators other than the at least one target operator in the to-be-quantized model, to obtain the corresponding iris image segmentation result.

In an implementation, the model precision corresponding to the target model is a preset precision;
when configured to perform image segmentation processing on the to-be-segmented iris image based on the at least one quantization operator in the target model and the operators other than the at least one target operator in the to-be-quantized model, to obtain the corresponding iris image segmentation result, the processing module 1604 is configured to:
adjust corresponding image precision of the to-be-segmented iris image based on the preset precision, to obtain a corresponding intermediate image, where image precision of the intermediate image corresponds to the preset precision,
perform image segmentation processing on the intermediate image based on the at least one quantization operator in the target model and the operators other than the at least one target operator in the to-be-quantized model, to obtain a corresponding intermediate segmentation result, and
perform precision adjustment on the intermediate segmentation result based on the image precision corresponding to the to-be-segmented iris image, to obtain the corresponding iris image segmentation result, where the image precision corresponding to the iris image segmentation result is the same as the image precision corresponding to the to-be-segmented iris image.

As an embodiment, the apparatus shown in FIG. 16 may be configured to perform the method in the embodiment shown in FIG. 2. Therefore, for functions and the like that can be implemented by functional modules of the apparatus, refer to the descriptions in the embodiment shown in FIG. 2, and details are not described herein again.

A memory 1701 is configured to store a computer program executed by a processor 1702. The memory 1701 may mainly include a program storage area and a data storage area, where the program storage area may store an operating system, a program required for running an instant messaging (IM) function, and the like. The data storage area may store various instant messaging information, operation instruction sets, and the like.

The memory 1701 may be a volatile memory, for example, a random-access memory (RAM). The memory 1701 may alternatively be a non-volatile memory, such as a read-only memory, a flash memory, a hard disk drive (HDD), or a solid-state drive (SSD). Alternatively, the memory 1701 is any other medium capable of being configured to carry or store a desired computer program having an instruction or data structural form and being accessed by a computer. This is not limited herein. The memory 1701 may be a combination of the foregoing memories.

The processor 1702 may include one or more central processing units (CPUs), or is a digital processing unit, or the like. The processor 1702 is configured to invoke the computer program stored in the memory 1701 to implement the foregoing quantification method for the image segmentation model.

A communication module 1703 is configured to communicate with a terminal device and other servers.

A specific connection medium between the memory 1701, the communication module 1703, and the processor 1702 is not limited in the present embodiment of this disclosure. In the embodiments of this disclosure, as shown in FIG. 17, the memory 1701 is connected to the processor 1702 via a bus 1704, and the bus 1704 is indicated by a bold line in FIG. 17. The connection modes between other components are merely illustrative and are not intended for limitations. The bus 1704 may be classified as an address bus, a data bus, a control bus, and the like. For ease of description, the bus in FIG. 17 is described by using only one bold line. However, this does not describe that there is only one bus or one type of bus.

The memory 1701 has a computer storage medium stored therein, the computer storage medium has computer-executable instructions stored therein, and the computer-executable instructions are configured for implementing the quantization method for the image segmentation model according to the embodiments of this disclosure. The processor 1702 is configured to perform the foregoing quantization method for the image segmentation model.

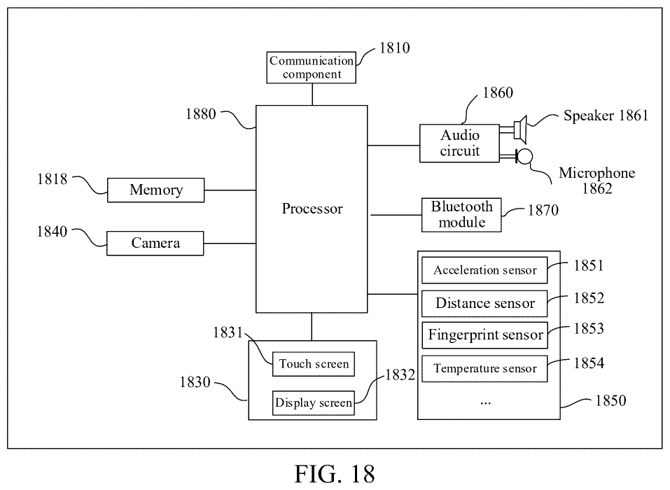

In another embodiment, an electronic device may alternatively be another electronic device, such as a terminal device 101 shown in FIG. 1B. In this embodiment, the structure of the electronic device may be shown in FIG. 18, including: components such as a communication component 1810, a memory 1818, a display unit 1830, a camera 1840, a sensor 1850, an audio circuit 1860, a Bluetooth module 1870, and a processor 1880.

The communication component 1810 is configured to communicate with a server. In some embodiments, a WiFi module may be included. The WiFi module belongs to a short-distance wireless transmission technology. The electronic device may help an object to receive and transmit information through the WiFi module.

The memory 1818 may be configured to store a software program and data. The processor 1880 executes various functions of the terminal device 101 and data processing by running software programs or data stored in the memory 1818.

The display unit 1830 may further be configured to display information inputted by the object or provide information and a graphical user interface (GUI) of various menus of the terminal device 101 to the object.

The physical terminal device may further include at least one sensor 1850, such as an acceleration sensor 1851, a distance sensor 1852, a fingerprint sensor 1853, and a temperature sensor 1854. The terminal device may further be configured with other sensors such as a gyroscope, a barometer, a hygrometer, a thermometer, an infrared sensor, an optical sensor, and a motion sensor.

The audio circuit 1860, a speaker 1861, and a microphone 1862 may provide audio interfaces between the object and the terminal device 101.

The processor 1880 is a control center of the physical terminal device and is connected to various parts of the entire terminal through various interfaces and lines. The processor executes various functions of the terminal device and performs data processing by running or executing a software program stored in the memory 1818 and invoking data stored in the memory 1818. In some embodiments, the processor 1880 may include one or more processing units. An application processor and a base-band processor may further be integrated into the processor 1880. The application processor mainly processes the operating system, a user interface, an application program, and the like, and the base-band processor mainly processes wireless communication. The foregoing base-band processor may either not be integrated into the processor 1880. In this disclosure, the processor 1880 may run the operating system, the application program, the user interface display, a touch response, and the method in the embodiments of this disclosure. In addition, the processor 1880 is coupled to the display unit 1830.

In specific implementations of this disclosure, object data related to the image segmentation model is involved. When the embodiments of this disclosure are applied to specific products or technologies, object permission or consent needs to be obtained, and collection, use, and processing of the related data need to comply with related laws, regulations, and standards of related countries and regions.

In addition, an embodiment of this disclosure further provides a storage medium, where the storage medium is configured to store a computer program, and the computer program is configured for performing the method provided in the foregoing embodiments.

An embodiment of this disclosure further provides a computer program product including a computer program, where when the computer program is run on a computer, a computer is caused to perform the method provided in the foregoing embodiments.

Although a plurality of units or sub-units of the apparatus have been mentioned in the detailed description above, such division is merely used as an example, but is not mandatory. Actually, according to the implementations of this disclosure, features and functions of two or more units described above may be implemented in one unit. On the contrary, the features and functions of one unit described above may be further divided to be implemented by a plurality of units.

In addition, although the operations of the method in this disclosure are described in a specific order in the accompanying drawings, this does not require or imply that these operations need to be performed in the specific order, or all operations shown need to be performed to achieve the expected result. Additionally, or alternatively, some operations may be omitted, a plurality of operations may be combined into one operation for execution, and/or one operation may be decomposed into a plurality of operations for execution.

It is noted that the embodiments of this disclosure may be provided as a method, a system, or a computer program product. Therefore, this disclosure may use a form of hardware-only embodiments, software-only embodiments, or embodiments combining software and hardware. Moreover, in this disclosure, a form of a computer program product that is implemented on one or more computer-usable storage media (including but not limited to a disk memory, a CD-ROM, an optical memory, and the like) that include a computer-usable program code may be used.

This disclosure is described with reference to flowcharts and/or block diagrams of the method, the device (system), and the computer program product according to the embodiments of this disclosure. Computer program instructions can implement each procedure and/or block in the flowcharts and/or block diagrams and a combination of procedures and/or blocks in the flowcharts and/or block diagrams. These computer program instructions may be provided to a general-purpose computer, a dedicated computer, an embedded processor, or a processor of another programmable data processing device to generate a machine, causing instructions executed by a processor of a computer or other programmable data processing device to produce an apparatus configured to implement a function specified in one or more processes of a flowchart and/or one or more blocks of a block diagram.

These computer program instructions may alternatively be stored in a computer-readable memory that can instruct a computer or another programmable data processing device to work in a specific manner, whereby the instructions stored in the computer-readable memory generate an artifact including an instruction apparatus. The instruction apparatus implements a specific function in one or more procedures in the flowcharts and/or in one or more blocks in the block diagrams.

These computer program instructions may further be loaded onto a computer or another programmable data processing device, causing a series of operations and steps to be performed on the computer or the another programmable device, to generate computer-implemented processing. Therefore, the instructions executed on the computer or the another programmable device provide operations for implementing a specific function in one or more processes in the flowcharts and/or in one or more blocks in the block diagrams.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of quantizing an image segmentation model, comprising:
obtaining a computational power evaluation result of a device that is to be deployed with the image segmentation model, the computational power evaluation result indicating operational performance of the device, and the image segmentation model comprising a plurality of operators;
selecting at least a first operator from the plurality of operators in the image segmentation model based on the computational power evaluation result, a data processing duration of the first operator on the device exceeding a threshold;
performing at least a quantization processing on the first operator based on a difference between the data processing duration of the first operator and a desired processing duration, to obtain a first quantization operator, a data processing duration of the first quantization operator on the device being less than the desired processing duration; and
converting, based on at least the first quantization operator, the image segmentation model into a target model for deployment onto the device.

2. The method according to claim 1, wherein the converting comprises:
building an intermediate model based on at least the first quantization operator and remaining operators other than at least the first operator in the image segmentation model;
determining a target precision based on the computational power evaluation result and a total desired processing duration for the target model; and
adjusting a model precision of the intermediate model based on the target precision, to obtain the target model.

3. The method according to claim 2, wherein the adjusting the model precision comprises:
adjusting the model precision of the intermediate model based on the target precision, to obtain a to-be-calibrated model;
obtaining a sample set, the sample set comprising at least a sample including a sample image and a sample segmentation result for the sample image;
testing, by using the sample set, the to-be-calibrated model in an operating environment that is configured based on hardware parameters of the device, to obtain at least a testing segmentation result of the sample, and at least an image segmentation duration for the sample; and
performing a model parameter adjustment on the to-be-calibrated model to obtain the target model, the model parameter adjustment being based on at least a deviation between the testing segmentation result of the sample and the sample segmentation result in the sample and at least a deviation between the image segmentation duration of the sample and the total desired processing duration.

4. The method according to claim 1, wherein the obtaining the computational power evaluation result comprises:
performing a data processing testing on the device based on a plurality of pieces of data, to obtain a testing processing duration of the data processing testing on the device; and
determining the computational power evaluation result based on the testing processing duration and a data quantity of the plurality of pieces of data.

5. The method according to claim 4, wherein the selecting at least the first operator comprises:
determining respective data processing durations of the plurality of operators for data processing on the device based on the computational power evaluation result; and
selecting at least the first operator from the plurality of operators based on the respective data processing durations of the plurality of operators and respective thresholds of the plurality of operators.

6. The method according to claim 1, wherein the performing at least the quantization processing comprises:
obtaining one or more quantization parameters of the first operator based on the difference between the data processing duration of the first operator and the desired processing duration; and
performing the quantization processing on the first operator based on the one or more quantization parameters and a precision of the first operator, to obtain the first quantization operator, a deviation between a precision of the first quantization operator and the precision of the first operator being within a preset range.

7. The method according to claim 1, the method further comprises:
deploying the target model in an operating environment having same hardware parameters of the device; and
performing, in the operating environment, an image segmentation processing on an iris image based on the target model to obtain an iris image segmentation result, the target model comprising at least the first quantization operator and remaining operators other than at least the first operator in the image segmentation model.

8. The method according to claim 7, wherein:
the target model has a preset precision; and
the performing the image segmentation processing comprises:
adjusting an image precision of the iris image based on the preset precision, to obtain an intermediate image, the intermediate image having the preset precision;
performing an image segmentation processing on the intermediate image based on the target model to obtain an intermediate segmentation result; and
performing a precision adjustment on the intermediate segmentation result to obtain the iris image segmentation result having a same image precision as the iris image.

9. An apparatus of quantizing an image segmentation model, comprising processing circuitry configured to:
obtain a computational power evaluation result of a device that is to be deployed with the image segmentation model, the computational power evaluation result indicating operational performance of the device, and the image segmentation model comprising a plurality of operators;
select at least a first operator from the plurality of operators in the image segmentation model based on the computational power evaluation result, a data processing duration of the first operator on the device exceeding a threshold;
perform at least a quantization processing on the first operator based on a difference between the data processing duration of the first operator and a desired processing duration, to obtain a first quantization operator, a data processing duration of the first quantization operator on the device being less than the desired processing duration; and
convert, based on at least the first quantization operator, the image segmentation model into a target model for deployment onto the device.

10. The apparatus according to claim 9, wherein the processing circuitry is configured to:
build an intermediate model based on at least the first quantization operator and remaining operators other than at least the first operator in the image segmentation model;
determine a target precision based on the computational power evaluation result and a total desired processing duration for the target model; and
adjust a model precision of the intermediate model based on the target precision, to obtain the target model.

11. The apparatus according to claim 10, wherein the processing circuitry is configured to:
adjust the model precision of the intermediate model based on the target precision, to obtain a to-be-calibrated model;
obtain a sample set, the sample set comprising at least a sample including a sample image and a sample segmentation result for the sample image;
test, by using the sample set, the to-be-calibrated model in an operating environment that is configured based on hardware parameters of the device, to obtain at least a testing segmentation result of the sample, and at least an image segmentation duration for the sample; and
perform a model parameter adjustment on the to-be-calibrated model to obtain the target model, the model parameter adjustment being based on at least a deviation between the testing segmentation result of the sample and the sample segmentation result in the sample and at least a deviation between the image segmentation duration of the sample and the total desired processing duration.

12. The apparatus according to claim 9, wherein the processing circuitry is configured to:
perform a data processing testing on the device based on a plurality of pieces of data, to obtain a testing processing duration of the data processing testing on the device; and
determine the computational power evaluation result based on the testing processing duration and a data quantity of the plurality of pieces of data.

13. The apparatus according to claim 12, wherein the processing circuitry is configured to:
determine respective data processing durations of the plurality of operators for data processing on the device based on the computational power evaluation result; and
select at least the first operator from the plurality of operators based on the respective data processing durations of the plurality of operators and respective thresholds of the plurality of operators.

14. The apparatus according to claim 9, wherein the processing circuitry is configured to:
obtain one or more quantization parameters of the first operator based on the difference between the data processing duration of the first operator and the desired processing duration; and
perform the quantization processing on the first operator based on the one or more quantization parameters and a precision of the first operator, to obtain the first quantization operator, a deviation between a precision of the first quantization operator and the precision of the first operator being within a preset range.

15. The apparatus according to claim 9, wherein the processing circuitry is configured to:
deploy the target model in an operating environment having same hardware parameters of the device, an image segmentation processing on an iris image being performed in the operating environment based on the target model to obtain an iris image segmentation result, the target model comprising at least the first quantization operator and remaining operators other than at least the first operator in the image segmentation model.

16. The apparatus according to claim 15, wherein:
the target model has a preset precision;
an image precision of the iris image is adjusted based on the preset precision, to obtain an intermediate image, the intermediate image having the preset precision;
an image segmentation processing is performed on the intermediate image based on the target model to obtain an intermediate segmentation result; and
a precision adjustment is performed on the intermediate segmentation result to obtain the iris image segmentation result having a same image precision as the iris image.

17. A non-transitory computer-readable storage medium storing instructions which when executed by at least one processor cause the at least one processor to perform:
obtaining a computational power evaluation result of a device that is to be deployed with a image segmentation model, the computational power evaluation result indicating operational performance of the device, and the image segmentation model comprising a plurality of operators;
selecting at least a first operator from the plurality of operators in the image segmentation model based on the computational power evaluation result, a data processing duration of the first operator on the device exceeding a threshold;
performing at least a quantization processing on the first operator based on a difference between the data processing duration of the first operator and a desired processing duration, to obtain a first quantization operator, a data processing duration of the first quantization operator on the device being less than the desired processing duration; and
converting, based on at least the first quantization operator, the image segmentation model into a target model for deployment onto the device.

18. The non-transitory computer-readable storage medium according to claim 17, wherein the instructions cause the at least processor to perform:
building an intermediate model based on at least the first quantization operator and remaining operators other than at least the first operator in the image segmentation model;
determining a target precision based on the computational power evaluation result and a total desired processing duration for the target model; and
adjusting a model precision of the intermediate model based on the target precision, to obtain the target model.

19. The non-transitory computer-readable storage medium according to claim 18, wherein the instructions cause the at least processor to perform:
adjusting the model precision of the intermediate model based on the target precision, to obtain a to-be-calibrated model;
obtaining a sample set, the sample set comprising at least a sample including a sample image and a sample segmentation result for the sample image;
testing, by using the sample set, the to-be-calibrated model in an operating environment that is configured based on hardware parameters of the device, to obtain at least a testing segmentation result of the sample, and at least an image segmentation duration for the sample; and
performing a model parameter adjustment on the to-be-calibrated model to obtain the target model, the model parameter adjustment being based on at least a deviation between the testing segmentation result of the sample and the sample segmentation result in the sample and at least a deviation between the image segmentation duration of the sample and the total desired processing duration.

20. The non-transitory computer-readable storage medium according to claim 17, wherein the instructions cause the at least processor to perform:
performing a data processing testing on the device based on a plurality of pieces of data, to obtain a testing processing duration of the data processing testing on the device; and
determining the computational power evaluation result based on the testing processing duration and a data quantity of the plurality of pieces of data.
